(19) United States
(12) Patent Application Publication
(10) Pub. No.: US 2005/0010859 A1
(43) Pub. Date: Jan. 13, 2005

(54) System for processing documents and associated ancillary information

(76) Inventors: Carol P. McDonough, Strafford, PA (US); Arthur J. Widmann, Exton, PA (US); Alexander Prusacki, King of Prussia, PA (US)

Correspondence Address: Alexander J. Burke;Intellectual Property Department, 5th Floor, 170 Wood Avenue South, Iselin, NJ, 08830, US

(21) Appl. No.: 10/886,140

(22) Filed: Jul. 7, 2004

Related U.S. Application Data
(60) Provisional application No. 60/485,890, filed on Jul. 9, 2003.

(51) Int. Cl. G06F 15/00

(52) U.S. Cl. 715/500

(57) ABSTRACT

A system processes document and associated ancillary information and includes a repository associating a first term with ancillary information and associating a second term with a subset of the ancillary information. A parser parses document formatting information associated with the document to determine whether the first and second terms are present in the formatting information. A data processor uses the repository to locate the subset of ancillary information and incorporates that subset of ancillary information in data representing at least a portion of a document associated with said formatting information, in response to a determination that the first and second terms are present in the associated formatting information.

This is a non-provisional patent application of provisional application Ser. No. 60/485,890, filed by C. P. McDonough et al. on Jul. 9, 2003.

### FIELD OF THE INVENTION

The present invention relates generally to the field of data processing, and more specifically to a system for processing a document containing data that includes ancillary information.

### BACKGROUND OF THE INVENTION

Computer accessible electronic storage systems have long existed which have the capability of housing large databases. An example of such a database storage scheme is a Laboratory Information System which provides access to numerous files, documents and related data. A Laboratory Information System typically includes records relating various medical data to patients. Documents are generated, containing specific desired patient medical data, for various entities related to the provision of healthcare services, such as patients, doctors, guarantors, insurance companies, and so forth. While such systems are programmed to provide storage for the standard medical data which is likely to be required, it is sometimes required that individual healthcare organizations store ancillary data of a type or types that was not foreseen, or was unforeseeable, by the system vendor, and that, thus, has not been programmed into the standard installation. A need exists for a user of such a database to be able to modify the database to hold data of a desired type, and to be able to place data of that type on a document.

In one example, the identity of the patient is uniquely specified in medical records using one or more of a predefined set of patient identifier types or fields, for example, medical record numbers, social security numbers and/or corporate account numbers. While the standardized protocol, format and/or content of this predetermined set of identifiers may meet the needs of users in some states and localities, the predefined identifier set often does not meet the needs of users in other countries or in other markets where, for example, individual provinces or jurisdictions have their own requirements for protocols, formats or codes for uniquely identifying patients.

Some prior database management systems have the ability to save, print and/or display customer or user-defined patient identifiers. However, in such systems the customer does not have actual control of the custom identifier implementation. Instead, such systems require the intervention of a computer programmer at installation time to implement the unique userdefined identifiers on behalf of each customer requesting them. Requiring a customer to seek the intervention and services of a programmer makes custom identifier implementation a cumbersome, inefficient and time consuming aspect of the actual information system installation process. A need exists for a user-defined identifier system that is directly accessible and controllable by the user without the need for intervention by or consultation with a professional database system manager or computer programmer.

In another example, sometimes, these reports require some form of attachment, such as a EKG record, an X-Ray or a sonogram. These attachments are generally saved in the form of a file. Because a vendor cannot know which attachments will be available in any patient's record, the vendor cannot at installation time know which reports a user will generate nor what medical data will be included in a report. The vendor, thus, cannot program data fields into the database to hold references to them. A need exists for a system which allows a user to include an attachment to a medical report.

### SUMMARY OF THE INVENTION

In accordance with principles of the present invention, a system processes document and associated ancillary information and includes a repository associating a first term with ancillary information and associating a second term with a subset of the ancillary information. A parser parses document formatting information associated with the document to determine whether the first and second terms are present in the formatting information. A data processor uses the repository to locate the subset of ancillary information and incorporates that subset of ancillary information in data representing at least a portion of a document associated with said formatting information, in response to a determination that the first and second terms are present in the associated formatting information.

### BRIEF DESCRIPTION OF THE DRAWINGS

FIG. 1 is a block diagram of a document processing system constructed according to the principles of the present invention;

FIG. 2 is an example of a report template according the principles of the present invention;

FIG. 3 is a graphical user interface used to facilitate implementation of the present invention; and

FIG. 4 is an example of a report produced according to the principles of the present invention.

### DETAILED DESCRIPTION OF THE INVENTION

The term ‘executable application’ as used herein comprises code or machine readable instruction for implementing predetermined functions including those of an operating system, healthcare information system or other information processing system, for example, in response user command or input. The term ‘processor’ as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. An object as used herein comprises a grouping of data, executable instructions or a combination of both or an executable procedure. A display processor or generator is a known element comprising electronic circuitry or software or a combination of both for generating display images or portions thereof.

In a healthcare enterprise environment, systems according to invention principles provide for storing, printing and/or displaying of user-defined keywords. That is, the system inherently supports the ability to add keywords to a patient report template. This mechanism may be used, in a manner to be described below, to implement one or more user-defined data types defining ancillary data. That is, data types which are not preprogrammed into the healthcare enterprise database and ancillary data which is not stored in the database. This enables user-created and defined data types and associated ancillary patient data to appear on the printed, displayed or transmitted report.

One such user-defined data type may be user-defined patient identifiers. Such user-defined patient identifier types may be used like any of the existing system-defined patient identifier types. The user-defined patient identifiers may be used to supplement the system-defined patient identifier types, or may be used as the primary identifier type for an institution. They may be sent and received during interface transactions, they may be used for searching for a patient record, and/or they may be displayed or printed on a report that generally includes patient identifiers. The system, thus, supports the displaying, printing or transmitting of an unlimited number of identifier types, including user-defined identifier types, on a patient report.

Another such user-defined data type may be attachment, or link to an attachment file. This may be used to track attachment files and to make them available to be included with documents generated based on patient data. Once attached to a patient document, the attachments may be displayed, printed or transmitted along with the remainder of the document.

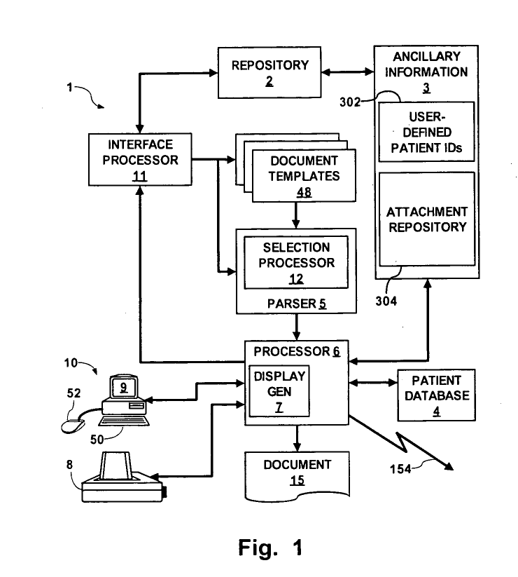

FIG. 1, illustrates one embodiment of a document processing system 1. The system 1 includes a data processor 6 which may be accessed by a user via a workstation 10 which is capable of sending and receiving information via various means such as a keyboard 50, a displayed image 9 and/or a mouse 52 or other pointing device (not shown). The data processor 6 may also communicate with other processors or a network via a communications link 154. The data processor 6 executes executable applications that are part of a Laboratory Information or Laboratory Assistant computer program that is used to facilitate the collection and exchange of information in a laboratory environment. The embodiment illustrated in system 1 is adapted to facilitate the automation of the patient admissions and tracking process by a healthcare provider.

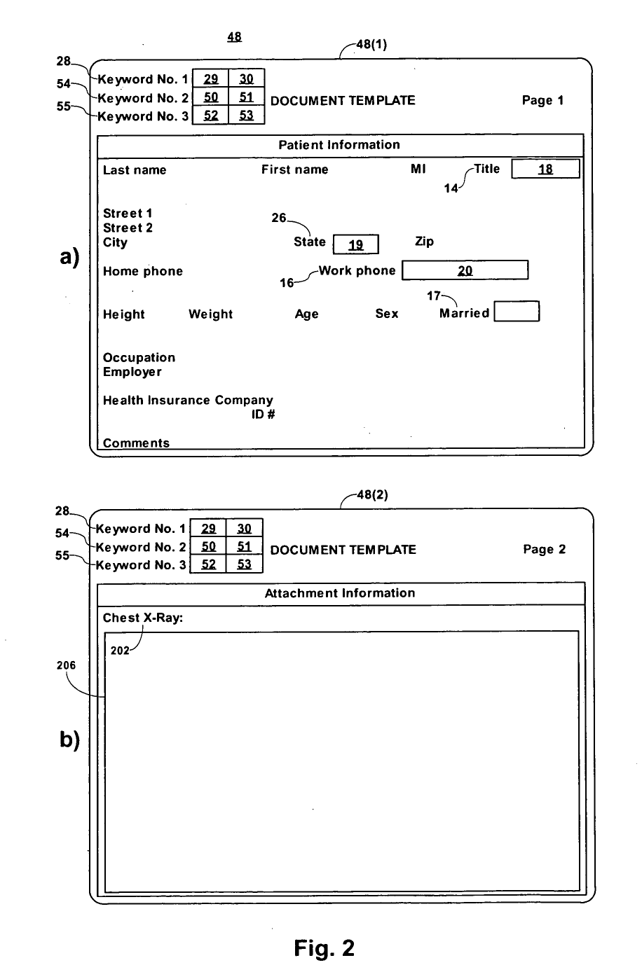

FIG. 2 illustrates an example of a document template 48 containing formatting information that specifies the presentation layout of a report or document 15 (FIG. 1). In FIG. 2, the document comprises two pages: page 1, 48(1), in FIG. 2a and page 2, 48(2), in FIG. 2b. The document template 48 specifies the location on the report or document 15 (FIG. 1) of patient data that is commonly collected, stored and used by a healthcare provider for each patient who is receiving service. In FIG. 2a, the document template 48(1) includes indicia indicating the location and content of fixed and generalized text, such as, for example, labels “Title” 14, “State” 26, “Work Phone” 16 and “Married” 17. The document template 48(1) also includes indicia indicating the location at which patient information is to be displayed for, and/or supplied or updated by, the user. For example fields 18 (to contain the patient's title), 19 (to contain the patient's state) and 20 (to contain the patient's work phone number) indicate the location of the specified patient information. The document template 48(1) also includes keyword fields 29 and 30, 50 and 51, and 52 and 53 along with respective label text 28, 54 and 55.

A document 15 (FIG. 1) is derived from the document template 48 and includes the fixed and generalized text and stored patient information at the locations indicated in the document template 48. More specifically, many, if not all, of the fixed text entries are followed by fields, such as, for example, fields 18, 19 and 20. The fields are used to display previously entered patient information. Referring to FIG. 1, patient data is stored in a storage device 4 in a known database arrangement. The processor 6 places data representing the fixed text within data representing at least a portion of the document associated with the formatting information so that the fixed text is displayed at the appropriate locations in the document 15. The processor 6 also accesses the patient database 4 to extract the patient data required by the fields in the document template 48 and places data representing the patient data within data representing at least a portion of the document associated with the formatting information so that the patient data is displayed in corresponding fields at the appropriate locations in the document 15.

The completed document 15, with fixed text and patient information, may be displayed on the display device 9 via the display generator 7 in the workstation 10, may be printed on the printer 8 and/or may be sent in a message to another location via the communications link 154. In addition, the user at the workstation 10 may provide or update patient information in the fields (18, 19, 20) using input devices such as the keyboard 50 and/or mouse 52. For example, the user may see, and/or may enter or update the patient's work phone number in the field 20 associated with the label 16, and so forth. The processor 6 will display any changes made to the field 20 in the document 15 displayed on the display device 9 and will also update the patient data in the patient database 4 with that updated data. Similarly, keyword fields 29 and 30, 50 and 51, and 52 and 53 may be displayed next to their respective labels 28, 54 and 55 on the document 15 derived from the document template 48 and keyword data may be entered or updated by the user.

Document templates 48 can be accessed and edited by the user to produce a variety of documents 15 having different layouts fulfilling different requirements of respective users. Using known editing techniques, a user may enter fixed and generalized text and available data fields, and arrange their location in the document or report 15 until they are satisfactory.

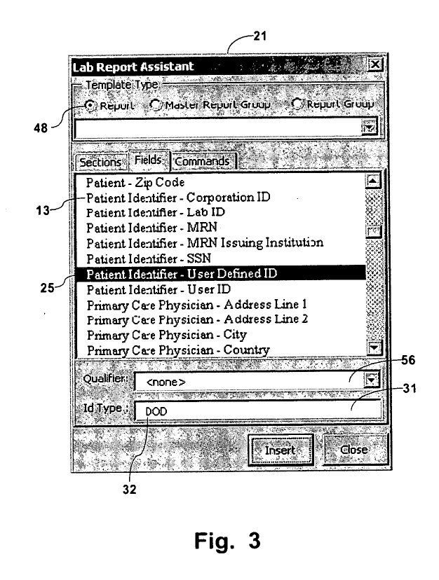

FIG. 3 illustrates a graphical user interface 21 that may be displayed via the display generator 7 on the display device 9 (FIG. 1) that permits a user to specify characteristics of the document template 48. One such characteristic is the insertion of data representing data fields into the formatting information in the document template 48 to contain patient data in the document 15. The “Fields” tab in the user interface 21 allows a user to select and insert a data field for patient data of a designated type. The available patient data field types are listed alphabetically in a menu on the “Fields” tab. For example, selecting the menu item “Patient Identifier—Corporation ID” 13 and pressing the “Insert” button, inserts a data field into the document template 48 to contain the corporation ID for the selected patient. The user may then resize and/or move this field to the desired location.

This mechanism may be used to insert user-defined data fields, for holding ancillary data, that is, data which is not preprogrammed into the patient database 4 (FIG. 1), into the document template 48. A plurality of different user-defined ancillary data types may be defined. As described above, keyword fields may be used to provide this function. A keyword used for this function is partitioned into a first portion containing a first term and a second portion containing a second term. In the illustrated embodiment, these two terms are user-determinable character strings. The value of the first term identifies the keyword as representing a user-defined ancillary data type and specifies the ancillary data type. The second term defines which particular data item of the selected data type, or which portion of such a data item, is represented by that keyword.

For example, the graphical user interface illustrated in FIG. 3 may be used by a user to add a user-defined patient identifier field to a document template 48 (FIG. 1, FIG. 2), to augment or replace the system-supplied patient identifier fields. In this case, the user selects the menu item “Patient Identifier—User-defined ID” 25. When the User-Defined ID menu item 25 is selected, the user interface 21 includes or activates a textbox 31. The user enters within the textbox 31 the name, abbreviation or mnemonic describing the type of the identifier 25. For example, in FIG. 3, the user-defined ID type 32 is designated by the user as “DOD”, which may stand for the Department of Defense. The user may then press the “Insert” button to insert a data field into the document template 48 to contain patient identification data of the user-defined type. The system 1 provides the ability to display an unlimited number of patient ID types, both predefined such as identifier types 13 and user-defined such as 25.

For a user-defined patient ID, the first term has a value which indicates that this keyword represents a user-defined patient ID. The second term has a value which indicates which user-defined patient ID type is represented by the keyword. In response to pressing the “Insert” button, a keyword field, and the associated keyword representative data item is placed in the document template 48, where it may be further manipulated by the user as described above. More specifically, when the “Patient Identifier—User Defined ID” 25 field is inserted into a document template 48 (FIG. 1, FIG. 2), the processor 6 generates a keyword representative data item in which the first term has the value specifying that this keyword represents user-defined patient ID ancillary data. The ID type 32 specified in the text box 31 is used to generate the second term for the keyword representative data item and indicates that this keyword represents a DOD patient identifier. This keyword representative data item is associated with the data field when it is inserted into the document template 48.

Referring again to FIG. 2, three keywords are illustrated in the upper left hand portion of the document template 48. A first keyword is preceded by a label 28 and is represented by respective first and second terms 29 and 30; a second keyword is preceded by a label 54 and is represented by respective first and second terms 50 and 51; and a third keyword is preceded by a label 55 and is represented by respective first and second terms 52 and 53. These keywords may be configured to represent user-defined patient identifiers in the manner described above, and the labels may be changed to better reflect the type of user-defined patient identifier. Continuing the above example, label 28 may be changed to “DOD identification” and the keyword 29,30 may hold the DOD patient ID.

Referring now to FIG. 2b, page 2 of the document template 48(2) also includes indicia indicating the location and content of fixed text: “Chest X-Ray:” 202. The document template 48(2) also includes indicia indicating the location at which attachment information is to be displayed. In FIG. 2b, this is a frame 206 within which an image of a chest X-Ray is intended to be displayed. The document template 48(2) also includes keyword fields 29 and 30, 50 and 51, and 52 and 53 along with respective label text 28, 54 and 55. these keyword fields contain the same information as those illustrated on page 1 of the document template 48(1). They are present to display patient ID information on page 2 of the document template 48(2) and the corresponding page of the report 15 based on the document template 48.

The graphical user interface 21 (FIG. 3) may be used in the same manner described above to insert a field to display ancillary information representing an attachment. In this case, the user may select a menu item in the “Fields” tab describing the desired attachment. For example, a menu item (not shown) may be “Attachment—User-Defined”, or may be more specific, such as “Attachment—X-Ray—User-defined” or “Attachment—Laboratory Report—User-defined”. These menu entries, although not illustrated would be listed at the appropriate alphabetical position in the list of fields displayed in the menu under the “Fields” tab. When the user selects one of the ‘attachment’ menu entries and presses the “Insert” button, a data field is inserted into the document template 48 to contain the attachment related to the selected patient.

As described above, keywords are used to implement this function. In this case, the first term has a value which indicates that this keyword represents attachment ancillary information. The second term has a value which indicates which type of attachment is represented by the keyword. When the “Attachment—User-Defined” menu item is selected, the text box 31 is again included or activated. The user enters the name, abbreviation or mnemonic describing the type of attachment. Continuing this example, “Chest X-Ray” may be entered into text box 31 as the attachment type 32. A second text box 56 may also be displayed or activated to accept a file name and/or location of the attachment, if it is known at the time the document template 48 is created.

Alternatively, a portion of an attachment may be indicated. For example, if the attachment is large, such as a textual patient medical record, then a portion of that medical record may be specified to be displayed. This may be done by specifying a date range, or a portion of the medical record relating to one medical condition, and so forth. In this case, “Medical Record” may be entered into the text box 31 as the attachment type 32, and a date range or other search criteria (specifying the medical condition) may be entered into the text box 56.

As described above, the processor 6 generates keyword representative data item in which the first term has the value specifying that this keyword represents a user-defined attachment ancillary data. The attachment type specified in the text box 31 and file name, if known, or desired portion of an attachment specified in text box 56 are used to generate the second term for the keyword representative data item. This keyword representative data item is associated with the attachment data field when it is inserted into the document template 48.

Referring again to FIG. 1, if the user-defined ID type has not been previously defined, then it is added to the system 1. A storage device 3 contains the ancillary information. The memory in the storage device 3 is partitioned into respective portions to hold data of the plurality of different user-defined data types. For example, in FIG. 1, memory in the storage device 3 is partitioned to hold patient data of the defined ancillary data types. More specifically, a partition 302 of the memory in the storage device 3 is allocated to hold user-defined patient IDs. The user-defined patient ID information 302 comprises the plurality of user-defined patient identifiers for the patients represented in the system 1. Similarly, a second partition of the memory in the storage device 3 is allocated as a repository 304 to hold patient data of the attachment type. The attachment repository 304 comprises the plurality of attachments related to the patients, either holding the attachments themselves or links to files containing the attachments in another storage device.

When an ancillary data type is newly defined, the processor 6 sends data representing the newly defined ancillary data type to the ancillary information storage device 3. The storage device 3 is configured to store ancillary data of the newly defined type. For example, memory space may be allocated to hold the newly defined type of ancillary data structured in a table-like manner in which each patient is represented by a row. Memory may then be allocated within the table to contain data representing the specific new user-defined ancillary type by adding a new column to the table.

For example, a column is allocated in a user-defined patient ID table to hold the DOD patient identifier data. The DOD patient identifier of a patient is stored in that column of the table in the row associated with the patient. Similarly, a column is allocated in an attachment table to hold either a chest X-ray image, or a link to a file containing data representing that image. One skilled in the art of data storage will understand that other data storage arrangements are possible in the ancillary information storage device 3 and will understand how to select and implement an appropriate arrangement. For example, a single table may be formed with rows representing patients and columns representing each type of ancillary information. Alternatively, storage arrangements other than tables may be used.

Referring still to FIG. 1, a user may supply data, e.g. representing a desired report or document type and a patient, to the processor 6 through the input devices 50 or 52 to condition the processor 6 to generate a document 15. The processor 6 supplies this data to an interface processor 11. The interface processor 11 controls selection of a document template 48 from among the plurality of available document templates 48, which will generate a document 15 of the desired document type. A parser 5 includes a selection processor 12 which selects the desired document template 48 under the control of the interface processor 11. As described above, the document template 48 includes formatting data specifying location and content of fixed text and data fields. The parser 5 analyzes this data in the selected document template 48 to determine what fixed text is to be placed in the document 15 and where it is to be placed. The parser 5 also analyzes what data fields are in the document template 48 and where they are to be placed. The results of the analysis performed by the parser 5 is supplied to the processor 6.

In response, the processor 6 generates a document 15 by placing data representing the fixed text and data fields within data representing at least a portion of the document associated with the formatting information in the document template 48 so that the specified fixed text and data fields are placed at the appropriate locations in the document 15 image. The processor 6 also retrieves patient data from the patient database 4 and places data representing that retrieved patient data within data representing at least a portion of the document associated with the formatting information in the document template 48 so that the retrieved patient data is displayed in the corresponding data fields at appropriate locations in the document 15 image. The display processor 7 processes this data to generate a document image on the display device 9.

If the parser 5 determines that the selected document template 48 includes a keyword field representing ancillary information, i.e. if the parser determines that a keyword including first and second terms is present in the formatting information in the document template 48, the processor 6 conditions the interface processor 11 to retrieve the data which represents that ancillary information. The interface processor 11 supplies the first term of the keyword to the repository 2. This portion has a predetermined value which specifies the type of ancillary information that this keyword field represents. For example, the first term may indicate that this keyword represents user-defined patient IDs, or an attachment, or some other type of ancillary information.

The repository 2, in turn, accesses the ancillary information storage device 3 and returns ancillary information of the specified type. The ancillary information returned to the interface processor 11 by the repository 2 comprises the ancillary information of the specified type for the selected patient. That is, if the keyword specifies user-defined patient identifiers, then the user-defined patient identifiers which have been defined for the selected patient are returned. Similarly, if the keyword specifies an attachment, then the attachments defined for the patient are returned. The interface processor 11 then selects a subset of that ancillary information, i.e. the particular user-defined patient identifier, the particular attachment, or the specified portion of the particular attachment, represented by the data field, by analyzing the second term portion of the keyword. Data representing the specified ancillary information (user-defined patient ID, attachment or portion of an attachment) is incorporated into data representing at least a portion of the document associated with the formatting information from the document template 48 by the processor 6.

In the case of an attachment, the attachment, or specified portion of the attachment, is placed in the appropriate location in a manner which depends on the type of the attachment. For example, if the attachment is an image, such as an X-ray, then the image is displayed in the frame defined in the document template 48. Alternatively, if the attachment is textual, such as a laboratory report, then the text, or specified portion of the text, is displayed in the frame defined in the document template 48. If the attachment is a sound, then an audio player is displayed in the frame defined in the document template 48 so that the user may control the playback of that sound. In such cases, the attachment is displayed in a manner appropriate for the type of attachment file defined.

The generated document 15 may then be displayed on the display device 9 via the display generator 7. The user may then see the patient data and associated fixed text, e.g. labels. As described above, the user may also supply or change data in data fields using the input devices 50 and/or 52. Supplied and/or changed data is updated in the appropriate one of the ancillary information store 3 and patient database 4. The user may also condition the processor 6 to print the document 15 on the printer 8 or send the document 15 to another location via the communications link 154.

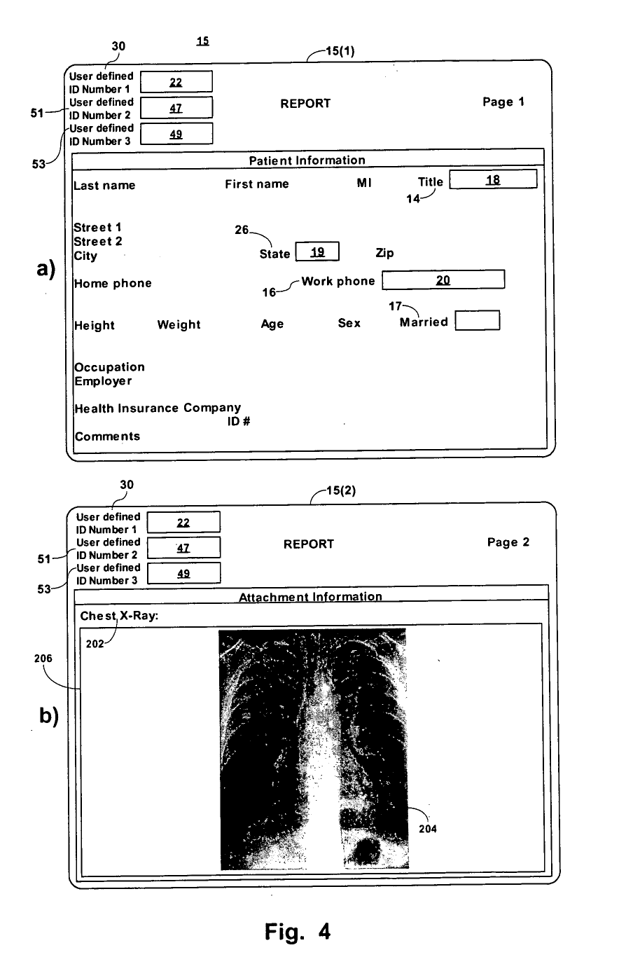

An example of a report 15 produced by the document template 48 is illustrated in FIG. 4. This document 15 corresponds generally to the document template 48 illustrated in FIG. 2. On page 1 of the report 15(1) and also on page 2 of the report 15(2), one of the keywords 29, 30 (FIG. 2) present in the document template 48 (FIG. 1) represents a first user-defined patient identifier with textual label 30: “User defined ID Number 1”. The contents of the field 22 contains text which represents the value of this patient identifier for the selected patient to which this document 15 is related as received from the ancillary information storage device 3 via the repository 2 and interface processor 11 (FIG. 1). Two other user-defined patient identifier fields, 47 and 49 are adjacent to respective labels 51 an 53. On page 1 of the report 15(1), the data fields 18, 19, and 20 contain textual data representing the patient data for the selected patient from the patient database 4. Similarly, on page 2 of the report 15(2), the attachment frame 206 is adjacent the label 202: “Chest X-Ray”. An image 204 of a chest X-ray is displayed in the frame 206. This image is received from the ancillary information storage device 3 via the repository 2 and interface processor 11.

The system described above allows a user to create documents and/or reports having a customized format that serves the needs of the user. The system also gives the user the ability to decide which and how many user-defined ancillary data types are included in, and where the data are placed on, the report. The configuration of this data is customizable to meet the needs of the recipient of the report.

A number of modifications to the embodiment just described are possible. Therefore, the present invention is not limited to the particular embodiment shown, and many different embodiments and modifications are included within the scope of the appended claims.

1. A system for processing a document and associated ancillary information, comprising:
a repository associating a first term with ancillary information and associating a second term with a subset of said ancillary information;
a parser for parsing document formatting information associated with a document to determine whether said first term and second term are present in said formatting information; and
a data processor for using said repository in locating said subset of said ancillary information and incorporating said subset of said ancillary information in data representing at least a portion of a document associated with said formatting information, in response to a determination said first and second terms are present in said associated formatting information.

2. A system according to claim 1, wherein said data processor processes said at least said portion of said document for at least one of, (a) printing, (b) communication and (c) display on a reproduction device.

3. A system according to claim 1, including a display generator for generating at least one image supporting user determination of said ancillary information.

4. A system according to claim 3, wherein:
said at least one image supports user determination of said first and second term; and
said first and second terms are user determinable character strings.

5. A system according to claim 1, wherein:
said ancillary information comprises a plurality of identifiers associated with a particular patient; and
said subset of ancillary information comprises a particular identifier of said plurality of identifiers.

6. A system according to claim 1, wherein said document formatting information comprises document template information determining a presentation layout of said associated document.

7. A system according to claim 1, including an interface processor for receiving identification information for identifying a document associated with a particular patient, said identified document being processed by said parser and said data processor.

8. A system according to claim 7, wherein said received identification information comprises at least one of, (a) a patient identifier, (b) a document identifier and (c) an identifier identifying a document associated with a particular patient.

9. A system according to claim 1, including an interface processor for receiving identification information for identifying a document associated with a particular patient; and
a selection processor for selecting said document formatting information from a plurality of different types of document formatting information in response to a determined type of said identified document.

10. A system according to claim 9, including a plurality of said first and second terms, wherein said selection processor selects from a plurality of different types of document formatting information including said plurality of said first and second terms.

11. A system according to claim 10, wherein said first and second terms include user determinable characteristics.

12. A system for processing a document and associated ancillary information, comprising:
an interface processor for receiving identification information for identifying a document associated with a particular patient;
a repository associating a first term with ancillary information and associating a second term with a subset of said ancillary information and associating said ancillary information with said received document identification information;
a parser for parsing document formatting information associated with said identified document to determine whether said first term and second term are present in said formatting information; and
a data processor for using said repository in locating said subset of said ancillary information and incorporating said subset of said ancillary information in data representing at least a portion of said identified document associated with said formatting information, in response to a determination said first and second terms are present in said associated formatting information.

13. A system according to claim 12, wherein:
said identification information identifies a type of said identified document; and
said parser selects said document formatting information from a plurality of different types of document formatting information in response to said identified document type.

14. A system according to claim 12, including a display generator for generating at least one image supporting user determination of said ancillary information.

15. A system according to claim 14, wherein said at least one image supports user determination of said first and second terms and said first and second terms are user determinable character strings.

16. A system according to claim 15, including an identification table, said first term being adapted to prompt said interface processor to query the identification table and return data residing within the identification table to said interface processor.

17. A system according to claim 16, wherein data residing within said identification table is returned to said interface processor in response to detection of user selected identification information within a document.

18. A system according to claim 1, wherein said ancillary information comprises information an attachment and said subset of said ancillary information comprises a portion of said attachment.

19. A system for processing a document and associated attachment information, comprising:
a repository associating a first term with attachment information and associating a second term with a subset of said attachment information;
a parser for parsing a document to determine whether said first term and second term are present in said parsed document; and
a data processor for using said repository in locating said subset of said attachment information and incorporating said subset of said attachment information in data representing at least a portion of said document, in response to a determination said first and second terms are present in said document.

20. A method for processing a document and associated ancillary information, comprising the activities of:
associating a first term with ancillary information;
associating a second term with a subset of said ancillary information;
parsing document formatting information associated with a document to determine whether said first term and second term are present in said formatting information; and
incorporating said subset of said ancillary information in data representing at least a portion of a document associated with said formatting information, in response to a determination said first and second terms are present in said associated formatting information.

21. A method according to claim 20, further comprising the activity of processing at least said portion of said document for at least one of, (a) printing, (b) communicating and (c) displaying said portion of said document on a reproduction device.

22. A method for processing a document and associated ancillary information, comprising the activities of:
receiving identification information for identifying a document associated with a particular patient;
associating a first term with ancillary information;
associating a second term with a subset of said ancillary information
associating said ancillary information with said received document identification information;
parsing document formatting information associated with said identified document to determine whether said first term and second term are present in said formatting information; and
incorporating said subset of said ancillary information in data representing at least a portion of said identified document associated with said formatting information, in response to a determination said first and second terms are present in said associated formatting information.
